(19) United States
(12) Patent Application Publication
(10) Pub. No.: US 2011/0213639 A1
(43) Pub. Date: Sep. 1, 2011

(54) AUTOMATED FEATURE-BASED ANALYSIS FOR COST MANAGEMENT OF DIRECT MATERIALS

(76) Inventors: J. Alan Stacklin, Naperville, IL (US); Stephen G. Eick, Naperville, IL (US); Brett Holland, Chicago, IL (US)

(21) Appl. No.: 12/714,125

(22) Filed: Feb. 26, 2010

(51) Int. Cl. G06Q 10/00; G06N 5/02; G06Q 50/00

(52) U.S. Cl. 705/7.31; 705/348; 706/47

(57) ABSTRACT

A system and method for managing costs of a target part is presented. The system and method entails five steps. First, the system and method provides features characteristics information of the target part. Second, system and method provides financial information related to the target part. Third, the system and method provides purchasing demand information related to the target part. Fourth, the system and method analyzes the features characteristics data, financial information, and purchasing demand information. Finally, the system and method compares the target part should cost to a supplier's price of the target part to determine cost saving opportunities.

### RELATED DOCUMENTS

This divisional application claims priority to U.S. Provisional Application No. 60/659,992 and U.S. Non-provisional application Ser. No. 11/372,937, each incorporated by reference herein.

### BRIEF DESCRIPTION OF THE DRAWINGS

FIG. 1 illustrates an overview of one embodiment of the invention;

FIGS. 2a-d comprise process modeling diagrams of the present invention;

FIG. 2e describes the assembly of FIGS. 2a-d to illustrate the process modeling diagram;

FIG. 3A illustrates one embodiment of the analytics layer;

FIG. 3B illustrates one method of sourcing analysis;

FIG. 3C illustrates one embodiment of the system architecture;

FIG. 3D illustrates the logical flow of a user's progression in the embodiment;

FIG. 4 illustrates the select parts by similar feature;

FIG. 5 illustrates the select parts by specific features;

FIG. 6 illustrates the cost savings opportunities summary;

FIG. 7 illustrates the select parts by category;

FIG. 8 illustrates the review parts for analysis in the analytics layer;

FIG. 9 illustrates the computations made during the analytics layer;

FIG. 10 illustrates the detailed parts analysis of a part;

FIG. 11 illustrates the cost drivers for a family of parts;

FIG. 12 illustrates a graphical representation of the cost drivers for a family of parts;

FIG. 13 illustrates the nearest neighbor analysis;

FIG. 14 illustrates the results sourcing analysis.

### SUMMARY OF THE INVENTION

A cost management system and method using an automated features-based system and process for analyzing costs of direct, made-to-order parts is described herein. More particularly, the system utilizes a software process that employs proprietary algorithms to analyze features of the target parts including their material, shape, as well as other characteristics and estimate what parts should cost to produce. By comparing the “should costs” with vendors' prices the system identifies cost saving opportunities.

The present embodiment utilizes information in CAD files and other drawings, analyzes key features and manufacturing characteristics of the selected components, and identifies cost relationships. It then uses these relationships to identify outliers, for example, parts that appear to be unusually expensive compared with what the model predicts that they should cost. Such parts are further analyzed to determine if they are candidates for cost reduction.

As part of its analytical models, one embodiment performs four primary calculations. First, based on part features, materials, manufacturing processes, and purchasing demand volumes, the embodiment calculates a “should cost” price for each part. It identifies outliers by comparing the “should cost” with the vendor's quoted price. Unusually expensive parts are candidates to be bid on by purchasing professionals, and thereby reduce costs. Second, it identifies key factors called “cost drivers,” which contribute to part costs. These key factors can be used by the engineering staff to minimize cost in the design process. Third, an embodiment of the system identifies similar parts called “nearest neighbors.” Last, it analyzes the capabilities of the suppliers to identify their core capabilities and thereby determines which parts are most efficiently sourced by each respective supplier.

The embodiment uses a top-down approach that can analyze an enterprise-wide set of data on purchased direct materials, quickly identify “sweet spots” that have the most cost reduction potential, and provide direction on how to attain cost savings. An embodiment of this invention can be used to funnel large amounts of data through a tool that will accurately pinpoint the specific opportunities that will give the most impact and efficiency in reducing costs. As such, the invention serves as the next generation of cost management tools that work in conjunction with existing cost management methods to accurately identify specific parts that are candidates for cost reduction and to steer the process used to obtain cost savings.

### DETAILED DESCRIPTION

A cost management system and method using an automated feature-based system and process for analyzing costs of parts is described herein. The cost management system may include a computer readable medium for storing information in one or more fields and a microprocessor that is coupled to the computer readable medium. The microprocessor may be programmed with instructions for manipulating the information. The cost management system may also include a display screen that is coupled to the computer readable medium. The display screen may be configured to display the information to a user of the cost management system and to permit selection of the one or more fields by the user. The cost management system may further include one or more software processes stored on the computer readable medium where such processes may be executed on the microprocessor. One or more of these software processes may allow a user to provide information to the cost management system, wherein such information may include one or more of features characteristics information of the target part, financial information related to the target part and purchasing demand information related to the target part. Moreover, one or more additional software processes may analyze the features characteristics information, the financial information, and the purchasing demand information and to determine a should cost of the target part (“target part should cost”) and to compare the target part should cost to a supplier's price of the target part to determine cost saving opportunities. This detailed description is presented in terms of programs, data structures or procedures executed on a computer or network of computers. The software programs implemented by the system may be written in languages such as Java, HTML, Python, or the R statistical language. However, one of skill in the art will appreciate that other languages may be used instead, or in combination with the foregoing.

For purposes of illustration, the invention relates to a system and software product directed to an analytical methodology for cost management of highly engineered made-to-order parts. In one embodiment, the system takes data from computer assisted drawings (CAD) files, engineering specifications files, demand data from Enterprise Resource Planning (ERP) systems, cost data from financial systems, and/or other electronic files and utilizes data mining algorithms to analyze part features, usage patterns, and engineering specifications to construct “should cost” curves across individual families of parts. Based on the should cost curves, the embodiment determine the significant cost drivers that affect the cost of the one or more target parts.

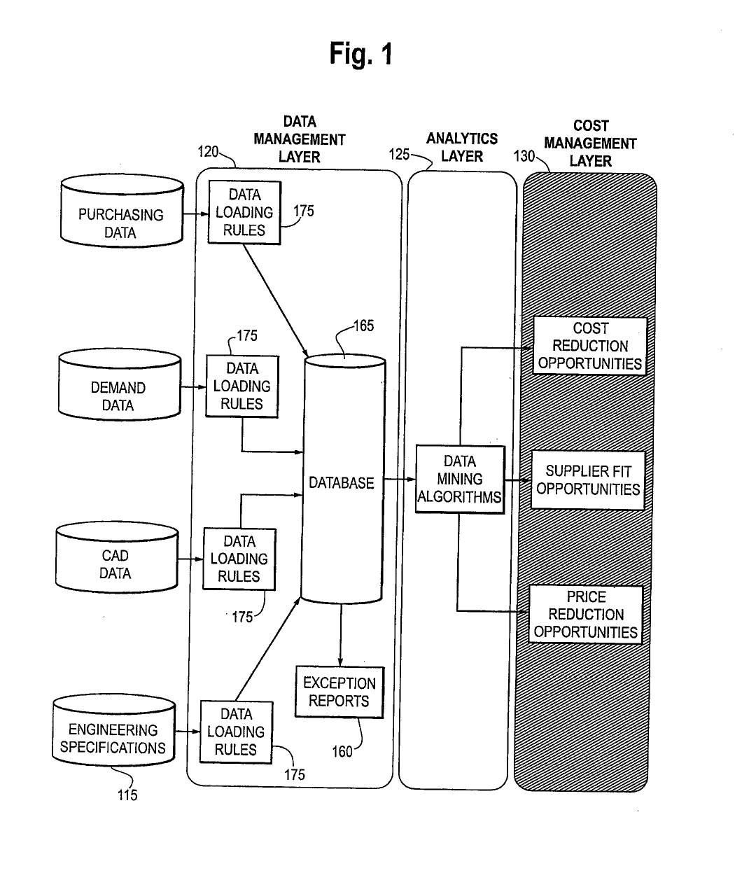

As best seen in FIG. 1, in one embodiment the system architecture consists of three distinct layers: the data management layer 120, the analytics layer 125, and the cost management layer 130. The data management layer 120 in the system architecture loads and manages customer data. The middle layer in the architecture is the analytics layer 130, which hosts various analysis algorithms that are required for invention models. The cost management layer 130 of the system architecture presents results in easy to understand and act-upon Cost Management Tools. In one embodiment, the cost management tools are presented to the user in a browser interface.

I. System Data Management Layer

In one embodiment of the system, the data management layer 120 consists of five parts. First, the system implements integration points that enable it to assimilate purchasing, financial, and part features information from the customer's internal systems. Within the integration points are data loading rules 175 the system uses as part of its data assimilation process. The reason for the data loading rules 175 is that each customer stores its parts purchasing and financial data using different formats. The data loading rules 175 aggregate data various customers and thereby enable the system to employ a business intelligence “should cost” database 165 that is reusable across customers.

The part features extraction process involves two types of information. The first type includes engineering specifications 115 that describe physical characteristics of the part. By processing these files the system can extract a set of physical features that describe the part. Examples of these features include material, e.g., which metal, height, width, and depth of the part, physical volume, number of cores, and characteristics of the drill holes. The second type of information involves machining specifications such as tolerances, smoothness, drill holes, drill hole volume, and parting line perimeter. There is a set of engineering specifications associated with each part. As a component the feature extraction process, the system processes each specification and extracts relevant information for cost modeling.

Second, using the data loading rules 175, the system transforms, normalizes and validates parts data as it is stored in the database 165. In one embodiment, the data loading rules 175 are written in the R statistical language.

Third, the system employs exception reports 160 that highlight unusual and suspect information. The reports, for example, identify unusually expensive parts or cheap parts, parts with missing weights, parts with no demand, suppliers, and many other characteristics of the data.

Fourth, the system analyzes 2D parts drawings and 3D engineering models of the parts and extracts features that are predictive of costs. In one embodiment, cost predictive features variables include financial information, purchasing information, and feature information. As best seen in TABLE 1, the features may involve part characteristics such as the volume of the part, which along with the density of the material, is used to calculate the part's weight, number of holes drilled into the part, type of drill used, number of cores, number of risers, surfaces, machine setups, and the like. One of ordinary skill in the art will appreciate that this table does not provide an exhaustive list, but is merely illustrative. The features characteristics are the primary drivers that enable the system's predictive models to achieve high accuracy.

TABLE 1
Cost Predictive Features Variables

| Financial | Purchasing | Feature |
|---|---|---|
| Information | Information | Information |
| Part Number | Segment | Material |

| | | |
|---|---|---|
| Part Name | Family | Aluminum |
| Engineering Change | Class | Brass |
| Number | Supplier | Ductile Iron |
| Forecasted Annual | Buyer | Gray Iron |
| Demand | Finishes Status | Malleable Iron |
| Demand Past 12 | (Rough, Semi, | Steel |

| | | |
|---|---|---|
| Months | Finished) | Casting Cost |

| | | |
|---|---|---|
| Base Part Price | Part Weight | Part Dimensions |

| Additional Charges | | Quoted Annual | Height |
|---|---|---|---|
| | Packaging | Demand | Width |
| | Painting | Quote Date | Depth |
| (Prime/Finish) | | | Surface Area |
| | Other | | Part Volume |
| | Material | | Box Volume |

| | |
|---|---|
| Surcharge | Finished Weight |

| | |
|---|---|
| Export Charges | Part Features |

| Storage/Warehousing | | Cores |
|---|---|---|
| | Tooling | Core Volume |
| | Premium Charge | Pressure test - Air |

Pressure test - Fuel
Pressure test - Oil
Pressure test - Water

Machining Cost

Direct

Ports
Port Volume
Drill Holes
Drill Hole Volume
Heat Treat
Parting Line Perimeter
Grinding
Machine Setups
Riser Removal
Surface Area Flatness

Indirect

Forecasted Annual
Demand
Log Annual Demand

Assembly Cost

Direct

Bearings
Fasteners
Seals

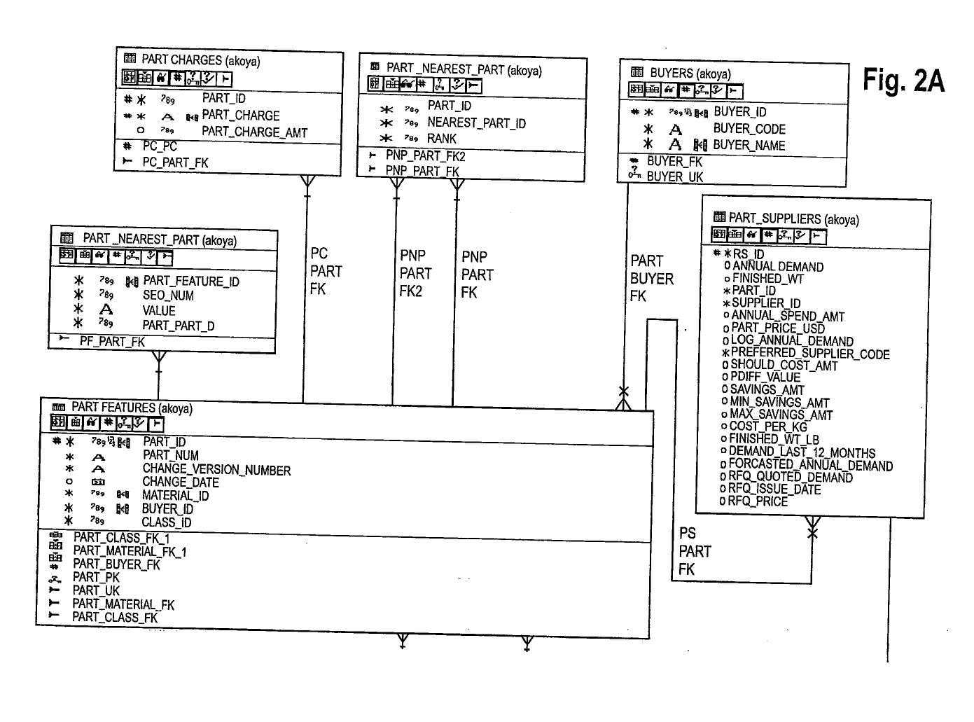

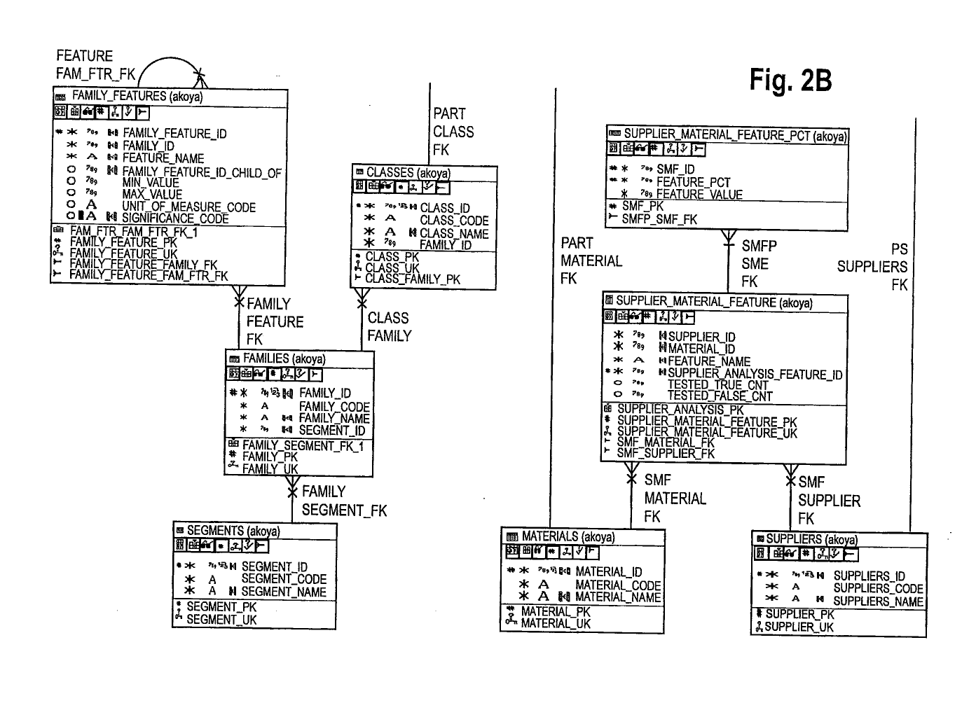

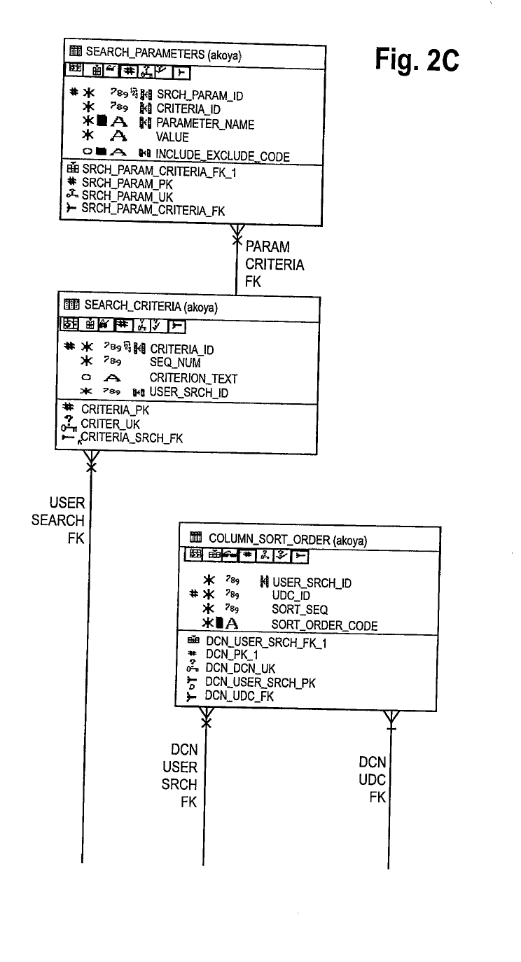

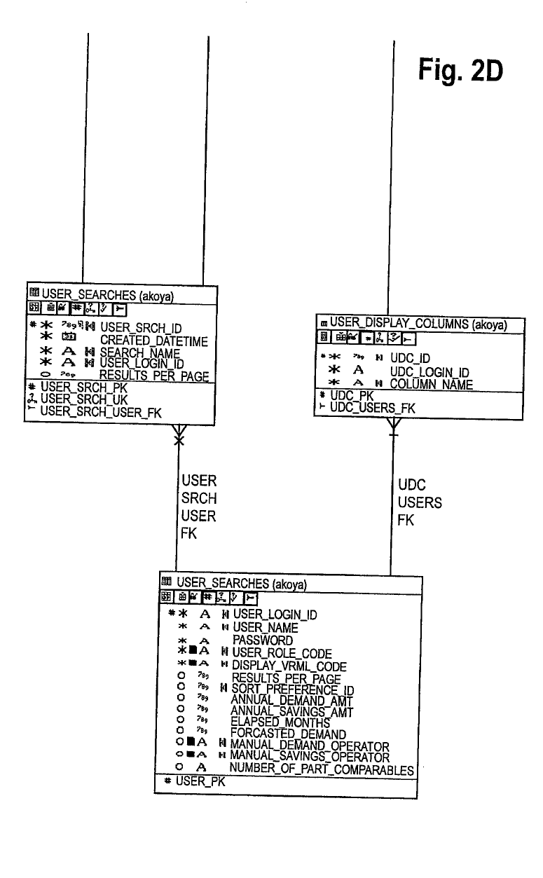

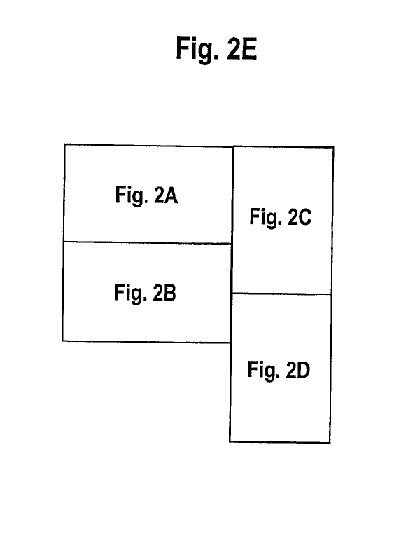

The fifth part of the system's data management layer is the database 165. In one embodiment, the system organizes parts data using snowflake schema data warehouse model with fact tables for parts and suppliers. An embodiment of the snowflake database schema is shown in FIG. 2a-2e. One of ordinary skill in the art will appreciate the snowflake schema is but one architecture of a data warehouse, and other schemas, including but not limited to a star schema, may be used.

It should be appreciated that part of this invention relates to choices of variables which may be loaded and data loading rules 175 used to process the data. There are many possible features that can be extracted from CAD data and many possible purchasing and demand variables. One aspect of the invention is the selection of variables and modeling techniques that are predictive of cost.

1. Data Management Architecture

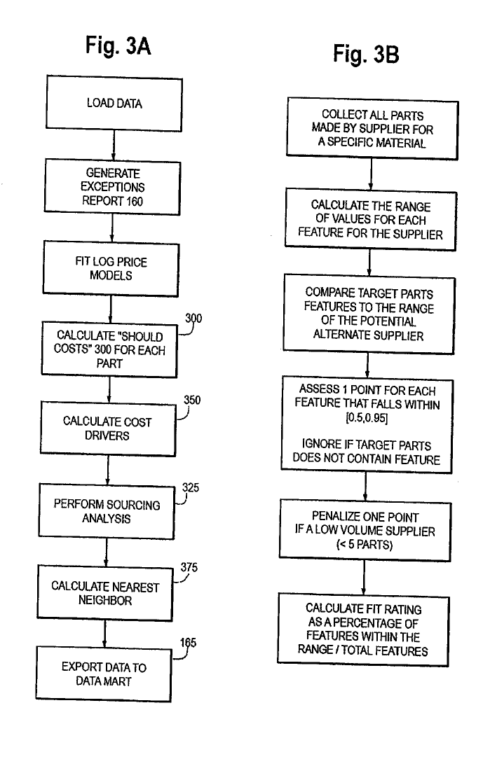

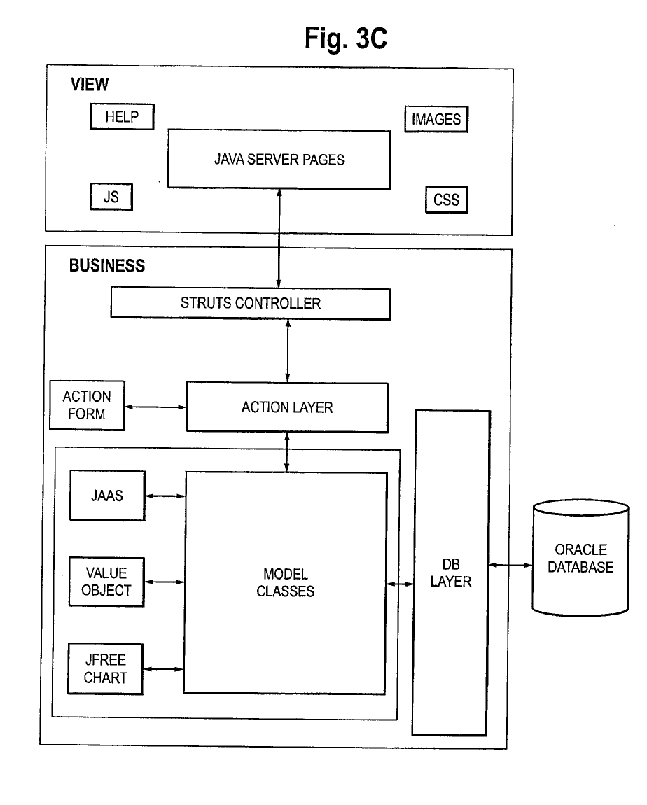

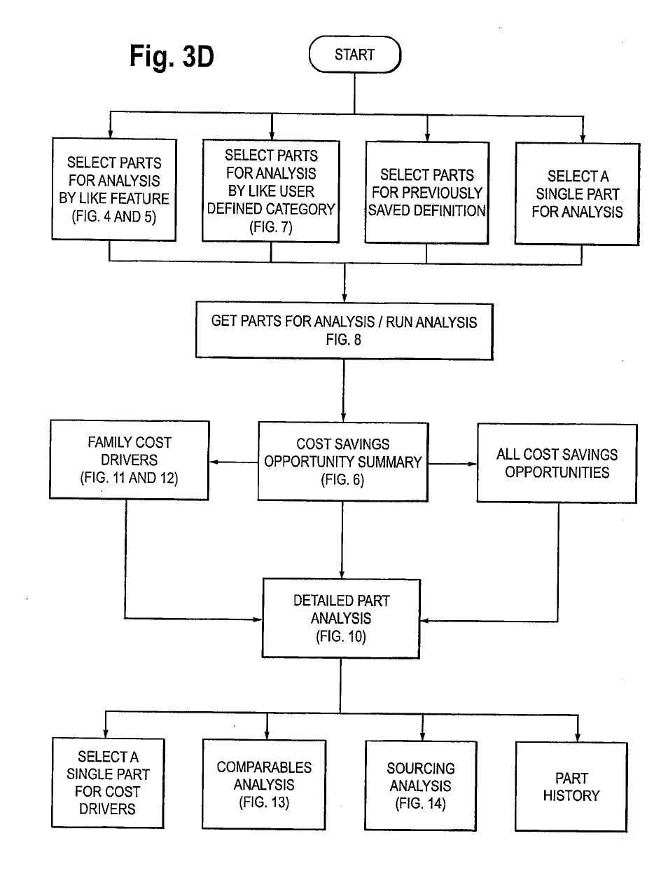

At the architectural level, one embodiment of the system performs data management functions using a four-step process, as best seen in FIG. 3A. In this embodiment, the data management process is performed as follows:

First, in one embodiment, the system extracts the data from the customer delivered formats and loads the files into memory. Next, the system aggregates, categorizes and filters the data based on customer defined rules. At this point, the system performs extreme value elimination by applying the data loading rules 175 and looking for extreme statistical values. The parts associated with the extreme values are eliminated from the data set under consideration. The system then takes the data from step 2 and loads it into database 165 for analysis. If a part is excluded from loading, the system will generate exception reports 160 which provide the user with information on any data load failures or exceptions. Once the data is properly loaded into the database 165, the analytics layer 120 performs model fitting algorithm analysis.

II. Analytics Layer

The second layer of the system's architecture is the analytics layer 125. This analytics layer 125 consists of a series of statistical routines that, in one embodiment, are implemented using the R Statistical Language. Further, this analytics layer 125 in the disclosed embodiment comprises two parts: the analytics module and analytics architecture.

A. Analytic Modules

As part of its analytical layer 125, an embodiment of the system performs four primary calculations. First, based on part features, material, manufacturing processes, and purchasing demand volumes, the should cost 300 module of the analytics layer 120 calculates a “should cost” price for each part. For purposes of illustration, “should cost” refers to the amount of money a part should reasonably cost. In this embodiment, the system identifies outliers by comparing the “should cost” with the vendor's quoted price. Outliers refer to parts which seem to be unusually expensive compared with what the model predicts that they should cost. Second, the cost drivers 350 module of the analytic layer 125 identifies key factors called “cost drivers,” which contribute to part costs. These key factors can be used by the engineering staff to minimize costs in the design process. Third, the nearest neighbor 375 module identifies similar parts called “nearest neighbors.” Last, the sourcing analysis 325 module of the analytics layer 125 analyzes the capabilities of the suppliers to identify their core capabilities and thereby determines which parts are most efficiently sourced which each respective supplier.

Should Cost—Predicting What Each Part should Reasonably Cost

The should cost 300 module models the costs of parts by predicting the price/kg for each part using generalized linear models.

a. Linear Combination Algorithm—Predicting the Price/kg

This algorithm predicts the log of the cost per kilogram of a part using a linear combination of features and categories.
log(costperkg)˜transform(dmd)+finwt.kg*material+boxvol+height+width+depth+risers*material+drillholeComp*material+surfarea*material+partingLinePerim*material+factor(hasCores)+nCores+factor(nCores)+coreVol+sqrt(coreVol)+sqrt(nCores)+factor(nCores)+heatTreat+sqrt(pressTestAir)+sqrt(pressTestOil)+sqrt(pressTestWater)+sqrt(pressTestFuel)+sqrt(drillholes)*material+nPorts+factor(rsf)+class.desc+nBearings+nSeal+NFasteners)+factor (material)

What should be appreciated is that our model does not predict “should cost” directly. Instead, for each family of parts, the algorithm predicts the log of cost per kilogram as a linear function of the log of the annual demand for parts, physical features of the part, machining costs, and engineering specifications. The type of material, which the model includes as a variable, is also important. The predicted “should cost” price is then the exponential of the predicted log cost per kilogram of the part.

In one embodiment of the system, models of this form are developed for all of the parts together and then again for each family of parts (e.g., Bonnets, Brackets, Covers, Housings, Elbows, and Supports). After the full model is fit, the embodiment refines its models using R's step procedure. In this embodiment, step applies the stepAIC algorithm. In this embodiment, the algorithm refines the model, adds and removes variables, and iterates until it finds the best fit. One skilled in the art will appreciate that other refinement procedures may be used and that the above described embodiment is not exclusive but merely illustrative.

1. Cost Drivers

In one embodiment, the cost driver 350 module identifies outliers by comparing the “should cost” with the vendor's quoted price. After outliers are eliminated, in a similar calculation to “should cost,” the cost drivers for a family of parts are predicted using a linear combination of features and categories. The system models the cost per kilogram of each part as:
costperkg˜finwt.kg(alum, duct, brass, iron, gray, steel)+boxvol+height+width+depth+risers+drillholes+drillHoleComp+surfarea+partingLinePerim+nCores+coreVol+heatTreat+factor(pressTestAir)+factor(pressTestWater)+factor(pressTestfuel)+factor(pressTestOil)+nBearings+nSeals+nFasteners+nPorts, +portVol, +flatness+log(demand)

What should be appreciated is that our model does not predict “cost drivers” directly. Instead, for each family of parts it predicts the cost per kilogram as a linear function of the log of the annual demand for parts, physical features of the part, machining costs, and engineering specifications. The type of material, which the model includes as an interaction term, is also important. The predicted “cost driver” price is then the exponential of the predicted log cost per kilogram of the part. In one embodiment, models of this form are developed for all of the parts together and then again for each family of parts (e.g., Bonnets, Brackets, Covers, Housings, Elbows, and Supports).

In one embodiment of the system, most predictive factors (cost drivers) and their relative effects are easy to interpret. FIG. 9 shows sample output from the system's Prediction Model. For the example illustrated in FIG. 9, certain key variables in the Model are marked with symbols, such as “***”, “**”, or “*”, to indicate their level of significance in the cost driver significance 900 column. In an embodiment of this particular model (model of a direct materials part analysis), the key variables for predicting costs include log (annual demand), box volume, part volume, drill holes, part type, material, and type of pressure test.

The relative effects of cost drivers for this example are shown in Table 2. The units in the table are incremental costs measured in cents per unit change in the cost driver. Thus, for example, on average a 10× increase in demand (logdmd) (1× in log scale) decreases the cost per kilogram of a part by $1.99.

TABLE 2
Cost Drivers and their relative effects in cents.

| | Incremental costs (¢/unit |
|---|---|
| Cost Drivers (CD) | change in CD) |
| Logdmd | −199.87 |
| Boxvol | 1.08 |
| Height | −.69 |
| Width | −.91 |
| Depth | −.50 |
| Partvol | −7.56e−5 |
| Drillholes | 9.80 |
| CoreVol | 7.54 |
| factor(class.desc)BONNETS | −24.20 |
| factor(class.desc)BRACKETS | −217.95 |
| factor(class.desc)COVERS | −333.12 |
| factor(class.desc)ELBOWS A | 229.05 |
| factor(class.desc)HOUSINGS | 297.75 |
| factor(class.desc)SUPPORTS- | −121.31 |
| ENGINE | |
| factor(heatTreat)Yes | −824.10 |
| factor(pressTestVal)Air | 129.85 |
| factor(pressTestVal)Fuel | 1767.42 |
| factor(pressTestVal)Oil | 332.38 |
| factor(pressTestVal)Unknown | −320.61 |
| Factor(pressTestVal)Water | −24.93 |
| factor(material.coarse)DUCT | −1233.37 |
| factor(material.coarse)GRAY | −1366.98 |
| factor(material.coarse)IRON | −1090.80 |
| factor(material.coarse)STLCAST | −359.44 |

It should be appreciated from linear regression theory that the parameters in Table 2 are the cost drivers that are displayed in the system's Cost Management Analysis (CMA) user interface. These parameters estimate the incremental costs for each of the features included in the model. In one embodiment of the system, these features are validated by applying the data loading 175 rules. It is sometimes the case that randomness in the statistical models results in aberrant estimates. The data loading 175 rules flag suspect values and provide explanations such as insufficient data in the case of extreme randomness.

2. Nearest Neighbor Algorithm—Identifying Similar Parts

The second class of system algorithms involves searching feature space to identify similar parts or nearest neighbors. In one embodiment, calculation of data structures subsequently applied to produce predictions and used in the nearest neighbor analysis is performed at data loading time or whenever new data is added to the system's database. The system uses pre-determined variables as feature vectors and defines these vectors as a point in feature space:

vᵢ=(v₁, v₂, . . . , vₙ)

where vᵢ is the value of feature i for the particular part under consideration. TABLE 3 shows a list of variables used in one embodiment of the nearest neighbor analysis. It should be obvious to one of ordinary skill in the art that the table is meant to be only illustrative and not exclusive. The system then normalizes each of the numeric features using the standard normal transform and in one embodiment calculates the Euclidean distance (d) between the points representing the different parts in feature space. One of skill in the art will appreciate that other distance metrics, besides the Euclidean, may be used.

d(vₚₐᵣₜ₁,vₚₐᵣₜ₂)=∥vₚₐᵣₜ₁−Vₚₐᵣₜ₂∥

where ∥ ∥ is the standard Euclidean distance function. When the user selects a target part, pre-selected feature variables of that part become reference points and the system then provides the distance between those target variables and all other parts. The nearest neighbor algorithm constrains the match so that certain attributes of the parts must match exactly, e.g., the parts must be made of the same material and be the same part type. Within this restricted class it enumerates all distances and returns the n candidates to the user interface.

TABLE 3
Variables for Nearest Neighbor analysis

| Comparables Analysis | Comparables Analysis |
|---|---|
| Variable | Variable Definition |
| Finwt | finished weight |
| height | height dimension |
| Width | width dimension |
| Depth | depth dimension |
| partvol | part volume dimensions |
| Surfacea | surface area dimension |
| partingLinePerim | parting line perimeter |
| | grinding |
| Risers | risers (removal) |
| Drillholes | number of drill holes |
| nPorts | number of ports |
| HeatTreat | heat treat of part |
| PressTestAir | pressure test air |
| PressTestFuel | pressure test fuel |
| PressTestOil | pressure test oil |
| PressTestWater | pressure test water |
| nCores | number of cores |

3. Sourcing Analysis—Evaluating the Suppliers

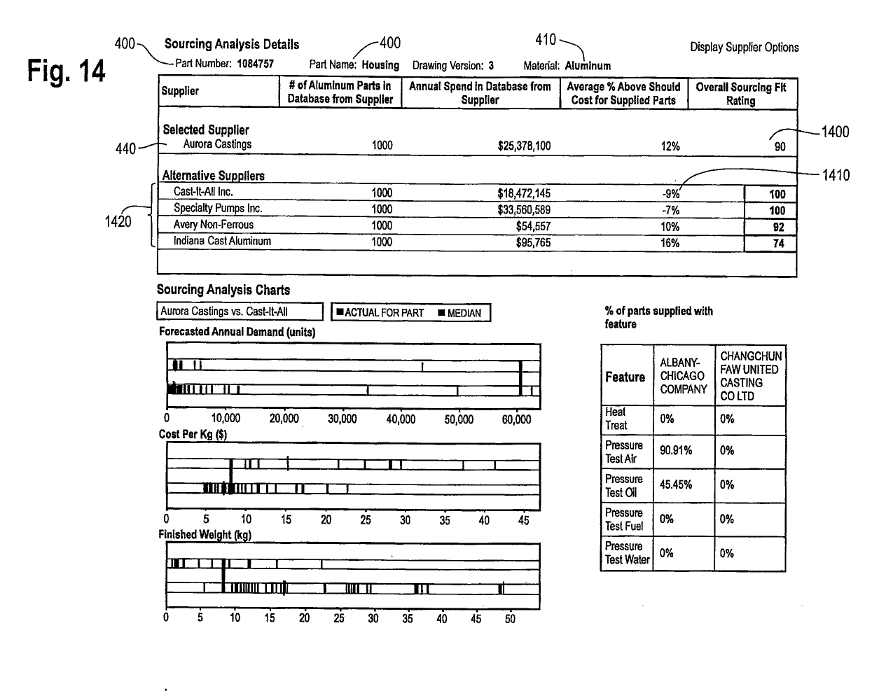

One possible reason for an over priced part maybe because it is sourced with a supplier who cannot produce it efficiently. For each part the system rates each supplier on an Overall Sourcing Fit Rating 1400, as shown in FIG. 14. An Overall Sourcing Fit Rating 1400 is calculated for each supplier by determining how far the target part is away from the range of efficiency for each supplier for each of the different part source variable categories, including but not limited to the variables listed in TABLE 4. One of ordinary skill in the art will appreciate that the table is meant to be only illustrative, and not exclusive. If the Overall Sourcing Fit Rating 1400 is low, it suggests that perhaps another source might be more appropriate for this part.

TABLE 4
FEATURE VARIABLES FOR OVERALL SOURCE FIT RATING
Feature Variables for Overall Sourcing Fit Rating

Cost per Kg
Annual Demand
Finwt/kg
Height
box volume
Surface area dimension
heat treated
Pressure Testing

Air
Fuel
Oil
Water

Average core volume
Average port volume
Average drill hole volume
Maximum flatness
is.assembly

The sourcing fit analysis works by analyzing the parts that each supplier produces, as shown in FIG. 3B. The first step in the calculation is to collect all parts made by supplier for a specific material. Next the system calculates the range of values for all part source categories for each part for each supplier. The system then compares the part source categories for the target parts features to the range of the source part values of each potential supplier. The system assesses 1 point for each feature that falls within [0.5,0.95]. If the target parts does not contain the feature, the system ignores it. Further, the system penalizes one point in cases of a low volume supplier. Using this scoring rating, the system calculates fit rating as a percentage of features within the range/total features.

The score percentage displayed in the user interface is the Score(p)/number of features checked. For each part, the algorithm checks every possible supplier, sorts them in reverse order, and displays the best suppliers. Ties for suppliers that have the same percentage are broken by sorting on pdiff, the percentage difference between should cost and the actual price.

B. Analytics Architecture

At the architectural level, one embodiment of the system performs system analysis, as best seen in FIG. 3A.

Using all of the parts data in the system's populated database 165, in an off-line process, the system runs several statistical and data mining routines that fit models. The fitting process results in sets of models and coefficients that are used in subsequent analysis. In addition, the system pre-calculates data structures that are subsequently applied to produce predictions and used in the nearest neighbor 375 module. As part of its off-line calculations, the system stores each part in the invention database for “cost reasonableness” and flags any unusual parts for further investigation. In one embodiment, model fitting and scoring are performed at data loading time or whenever new data is added to the system's database 165.

In this embodiment, as shown in FIG. 3A, the system analysis process is performed as follows:

Once the data is loaded into the database 165, as discussed above and shown in FIG. 3A, the system sequences the model fitting algorithms to ensure the proper fitting and results. Next, the system extracts data from the database 165 and loads that data into the analytical engine. The analytical engine then performs the following model fitting algorithms analysis based on input from the sequencer:

First, the system calculates the “should cost” price in the should cost 300 module. Here, for each part, in one embodiment, the system applies the log(costperkg) model from step 3 to predict the cost of each part. The predicted “should cost” value is compared with the vendor's price to identify large percentage differences, which one embodiment stores in a variable called pdiff. Parts with large positive pdiff's, e.g., parts that are much more expensive than predicted, are candidates for cost savings. The should cost 300 module is described at length above.

Next, the system calculates “Cost Drivers” from the cost drivers 350 module. Here, for each part family, in one embodiment, the system uses the R statistical language to fit linear regression that predicts should cost as a generalized linear function of the part's features. As with normal statistical theory, the coefficients in this model are the relative contributions of the particular features. The “cost driver” 350 module is described at length above.

Next, the system performs the “Nearest Neighbor” analysis in the nearest neighbor 375 module. Here, in one embodiment, for each part the system normalizes each feature to a (−1,1) scale and calculates the Euclidean distance between every part in feature space. Using this distance the system identifies the nearest parts and labels them neighbors. The nearest neighbor 375 module is described at length above.

Next, the system performs a Sourcing Analysis in the sourcing analysis 325 module. In one embodiment, this analysis involves analyzing every part in the dataset that each supplier produces and calculating the [0.5, 0.95] range of each feature. Then for each part the system, in one embodiment, scores each supplier on 16 possible features and give the supplier points each time the part's feature is in the [0.5, 0.95] range of the supplier's capability. In an alternate embodiment, the sourcing analysis 325 module may score each supplier for an alternate number of features and give the supplier points in a manner described above. The system also subtracts points in case of a low volume supplier. The rating of a supplier for a part is its total score/number of features evaluated. The calculation is performed by material for each supplier. The sourcing analysis 325 module is described at length above.

The last step involves pushing out the analytical results to a database 165. The CMA website then accesses the database 165 to provide information to CMA users. Users access the system's analytical routines, through the system's presentation layer, which is described below. A top level view of the CMA application architecture can be seen in FIG. 3C. For a description of the elements in the CMA application, see LEGEND 1 below.

LEGEND 1: Elements in CMA application Architecture

View
Java Server Pages - Jave Pages for UI
JS—Javascript
CSS—Cascading Style Sheets for web pages
Images—Images for web pages
Help—Third party help system
Business
Struts Controller—Part of the Apache Framework
Action layer—Part of the Apache Framework
Action Form—Unique forms for defining the actions of the action layer
JAAS—Java Authentication and Authorization Service
Value Objects—Objects used to define business rules
JFREE Chart—Third party charting object
Model Classes—Classes to interface between the action
layer and the database layer
DB Layer—Interface layer to the database

III. Cost Management Layer

The third layer of the system architecture is the cost management layer 130. The system's cost management layer 130 allows for the user to automatically group parts for analysis and provides a detailed analysis of cost saving opportunities.

A. Accessing the System

Users may access the system in one of three ways: (i) selecting parts by feature, (ii) selecting parts by category, or (iii) retrieving parts selected in previous analysis session. The logical flow of the cost management layer 130 is best represented by FIG. 3D.

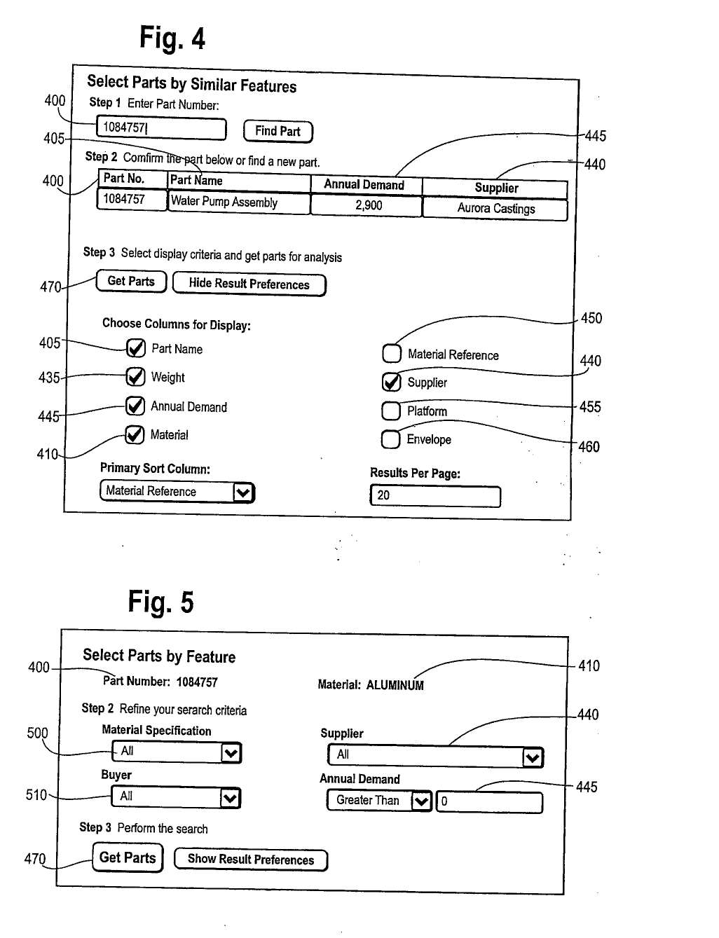

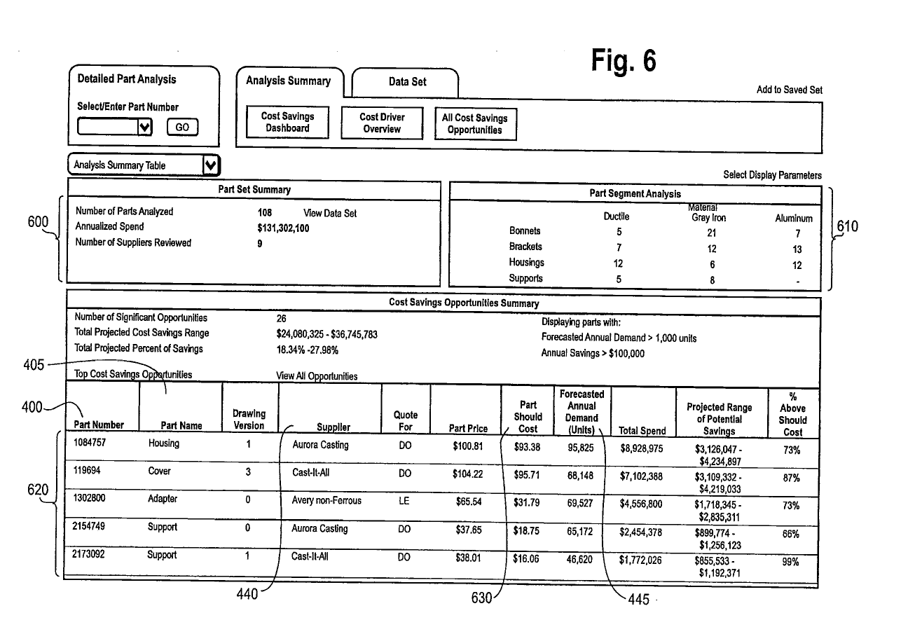

One way for the user to access the system is to search for parts by features, as best seen in FIG. 4. The user begins by inputting a part number 400 as a reference point. The embodiment then displays the part name 405, the part supplier 440, and the part annual demand 445. The user may then optionally select the columns for display such as the part name 405, the part weight 435, the part annual demand 445, the part material 410, the part material reference 450, the part supplier 440, the part platform 445, and the part envelope 460. The system will then use the nearest neighbor algorithm to find parts with similar features in the database to analyze and display the results. As best seen in FIG. 6, the search results display the part set summary 600, the part segment analysis 610, and the nearest neighbor list 620. The nearest neighbor list 620 set becomes the systems working set for this particular analysis.

In one embodiment of the system, as best seen in FIG. 5, the above-described search feature provides the user with the ability to refine the search criteria using several search filters including but not limited to part material 410, part buyer 520, part supplier 440 and part annual purchasing demand 445.

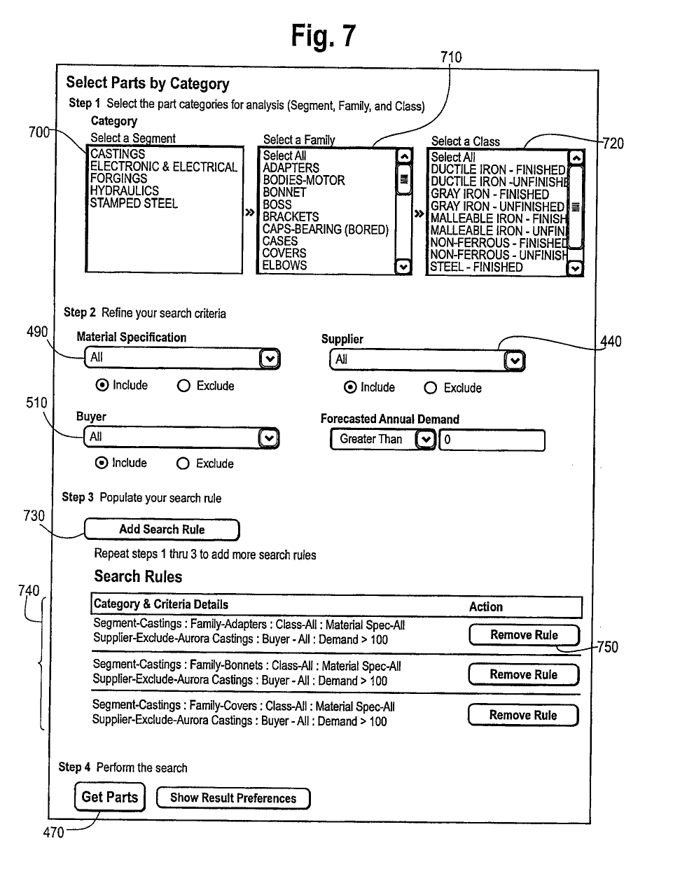

The second entry point to the system provides a Select Parts by Category mechanism for specifying a system database search. In one embodiment of the system, users can create search rules for category part searches. In this embodiment, system users may create rules by selecting parts segments 700, part families 710 and part classes 720 to include in the search rules as well as filters based on part material 410, part buyer 510, part supplier 440 and part annual purchasing demand 445. The search rule list 740 is displayed and the user may add a rule by engaging the add rule 730 function. Optionally, the user may remove a rule by engaging the remove rule 740 function. One of ordinary skill in the art will appreciate that the categories for creating search rules listed above are not exhaustive but are merely illustrative of possible search criteria. The system will apply these rules to select parts from the database 165 for analysis. The Select Parts by Category mechanism is shown in FIG. 7. Pressing the get parts 470 function submits the working set of parts, as modified by the user, to the system's analytic engines, described above.

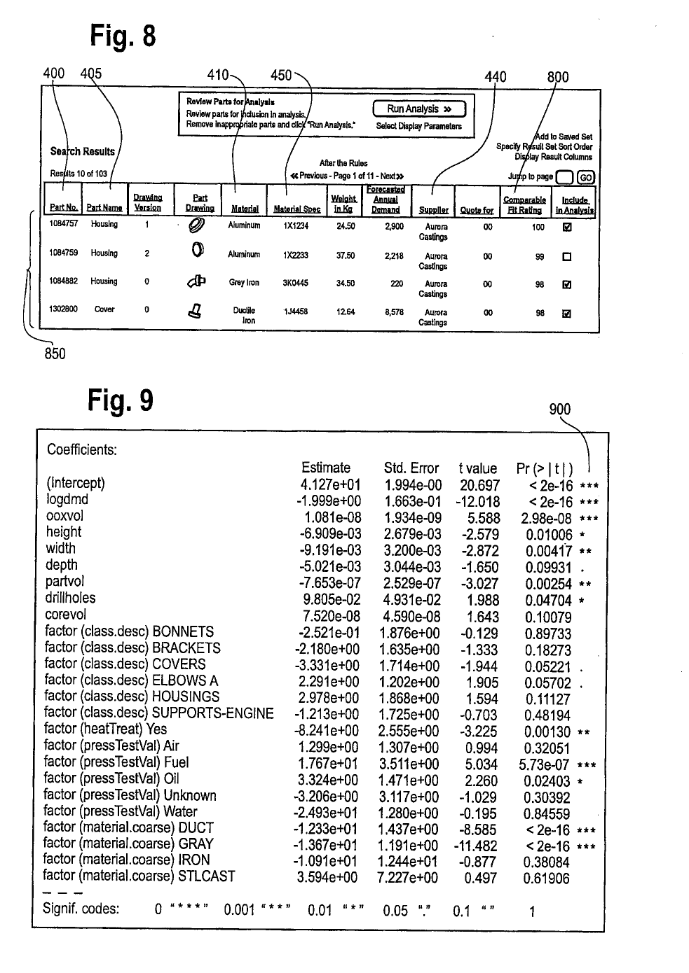

Third, users may review and “fine tune” their analysis working set using the dialogue shown in FIG. 8. In one embodiment, users may view their previous analysis set in a list 850 and then remove inappropriate parts or include additional parts in the analysis. Pressing the run analysis 875 function submits the working set of parts, as modified by the user, to the system's analytic engines, described above.

B. Cost Savings Opportunity Summary

Next, the system takes the results provided by the analytics layer 125 and presents the cost savings opportunities and their respective actions to the end user. For example, as can be seen in FIG. 6 the cost management layer 130 presents a top level summary of the parts analyzed. This includes a parts segment analysis 610, which lets the user know how the parts were segmented within the analysis and the top cost savings opportunities in order of potential savings. The analysis summary interface allows the user to access an overview of the cost drivers, and all cost savings opportunities, as well as access a detailed parts analysis for individual parts.

1. Detailed Part Analysis

The system's detailed part analysis shows the details of the analytic layer 125 applied to a single part. The system shows the user what the part should cost as well as what the current part does cost and the potential savings based on the parts demand. In addition, a summary of how each of the cost factors (pricing, sourcing, and design) are applied to that part.

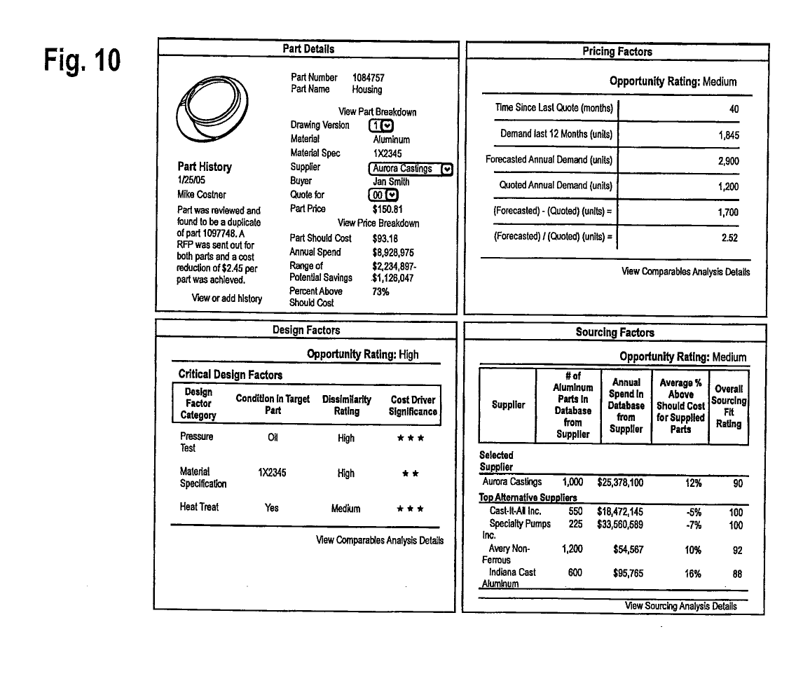

FIG. 10 shows an example report for a detailed part analysis on a single part. This report is broken into 4 quadrants, one that shows the part details including the calculated should cost, and the other three quadrants that display the cost factors related to pricing, sourcing and design. In one embodiment, the detailed parts analysis report allows the user to perform a comparables analysis, a sourcing analysis, and view the part's history.

2. Cost Driver Analysis:

The system Cost Driver Analysis provides the user with the cost model for a specific family of parts. This analysis details the costs associated with each of the parts parameters for a specific family of parts and shows graphically how the parts relate to each other.

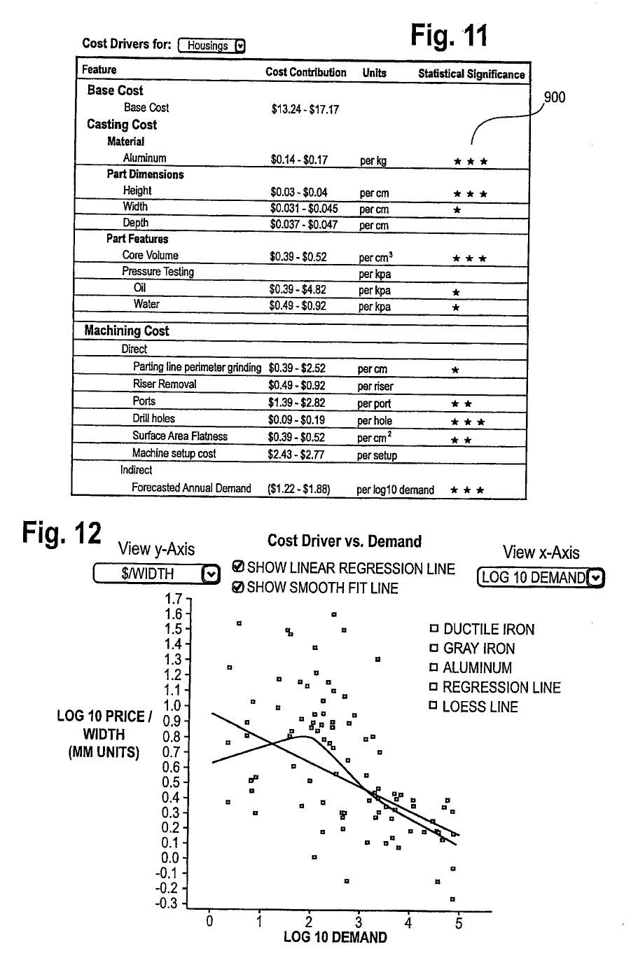

FIGS. 11 and 12 shows an example report for an invention Cost Driver Analysis on a family of parts.

3. Comparables Analysis

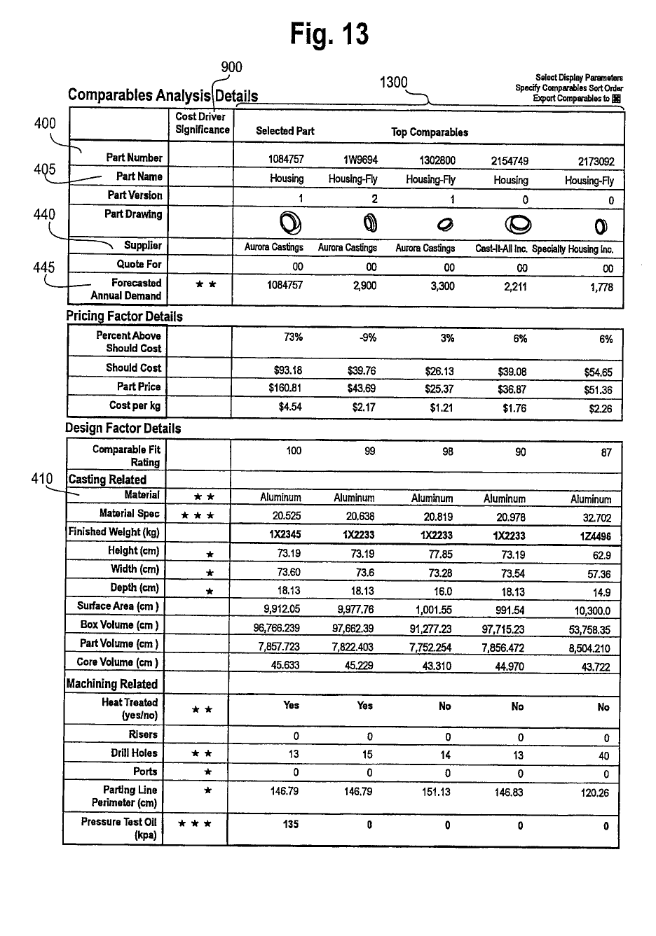

Referring now to TABLE 5, the nearest neighbor 375 module is used within the system to group parts based on like features (“comparables analysis”). This analysis is used when selecting parts by feature as well as when trying to find comparables to define redesign opportunities. The system nearest neighbor 375 module shows the users comparable parts as well as their characteristics. This analysis will show the user how similar parts are designed as well as provide the user with insight into design changes to the existing part that may reduce cost. FIG. 13 represents an example report for a nearest neighbor 375 module analysis for a single part.

TABLE 5

| partid | 2319329 | 2260299 | 2190628 | 2260302 | 2083729 | 1534212 |
|---|---|---|---|---|---|---|
| partname | HOUSING- | HOUSING- | HOUSING | HOUSING- | HOUSING | HOUSING |
| | FLYWHEEL | REAR | | FLY | | |
| costperkg | 38.83553 | 29.72777 | 5.697382 | 3.868642 | 5.521958 | 10.07332 |
| clssdesc | HOUSINGS | HOUSINGS | HOUSINGS | HOUSINGS | HOUSINGS | HOUSINGS |
| material.coarse | GRAY | GRAY | GRAY | GRAY | GRAY | GRAY |
| finwt.kg | 96.43 | 83.57 | 114.6 | 145.1 | 71.5 | 52.78 |
| height | 889.8 | 864.4 | 836.6 | 227.5 | 761 | 776.5 |
| width | 1253.4 | 1055.1 | 763.2 | 1240.7 | 761.4 | 500 |
| depth | 203.1 | 62.5 | 235.5 | 715.4 | 293.3 | 453.5 |
| partvol | 13709201 | 9319108 | 16235805 | 20374896 | 9108896 | 7437780 |
| risers | 0 | 0 | 0 | 0 | 2 | 0 |
| drillholes | 42 | 62 | 35 | 76 | 22 | 39 |
| spotFaceDrillHoles | 0 | 0 | 0 | 3 | 0 | 0 |
| surfarea | 2645594 | 1325145 | 2385837 | 2479172 | 1547739 | 1412496 |
| partingLinePerim | 2143.2 | 1919.5 | 1599.8 | 1956.2 | 1522.4 | 1276.6 |

4. Sourcing Analysis:

The system sourcing analysis 325 module determines the capabilities of a supplier by the parts they currently make. This analysis is used to help the user determine available options for re-sourcing a specific part, as well as understanding the current capabilities of their suppliers. FIG. 14 shows an example report for a sourcing analysis 375 module on a single part and its current supplier. This type of analysis can also be used to evaluate suppliers other than the current supplier.

### CONCLUSION

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects illustrative and not restrictive, the scope of the invention being indicated by the appended claims, rather than the foregoing description, and all changes which come within the meaning and range of equivalency of the claims are therefore intended to be embraced therein.

What is claimed is:

1. A method of managing costs of a target part comprising the steps of:
a) providing features characteristics information, of the target part;
b) providing financial information related to the target part;
c) providing purchasing demand information related to the target part;
d) analyzing the features characteristics data, financial information, and purchasing demand information;
e) comparing the target part should cost to a supplier's price of the target part to determine cost saving opportunities.

2. The method of claim 1, wherein the step of analyzing includes the determination of a should cost target part price.

3. The method of claim 2, wherein the step of analyzing also includes the use of statistical predictive models to determine the should cost target part price.

4. The method of claim 1, wherein the step of analyzing uses a statistical transform based upon features selected from the group consisting of demand and cost per weight.

5. The method of claim 4, wherein the demand transform is a log (demand) transform.

6. The method of claim 4, wherein the cost per weight transform is a log (cost per weight) transform.

7. The method of claim 1, including the further steps of providing said features characteristics information, financial information, and purchasing demand information related to a family of parts, and determining a prediction of a should cost for the family of parts.

8. A method of managing costs of a target part comprising the steps of:
a) providing features characteristics data of the target part;
b) providing financial information related to the target part;
c) providing purchasing demand information related to the target part;
d) analyzing the features characteristics data, financial information; and
e) determining from said analysis a prediction of cost drivers for the family of parts.

9. The method of managing costs of claim 8 wherein the predicted cost drivers for a family of parts is utilized to estimate the incremental costs of features involved in the manufacture of said family of parts.

10. The method of managing costs of claim 9, including the step of validating the features by applying business rules that identify potentially unreliable values and/or explain the random development of insufficient data.

11. The method of claim 8 wherein the cost drivers are derived for families of highly machined parts similar to the target part.

12. The method of claim 8 wherein the step of analyzing includes the step of managing target part costs by identifying a family of comparable parts, the family of comparable parts calculated from features characteristics data of the target part.

13. The method of claim 2 wherein the data managing layer acquires the features characteristics information from computer assisted design (CAD) files and/or other drawings related to the target part, analyzes predetermined physical features of the target part, and identifies cost relationships between the target part and similar parts.

14. The method of claim 13 wherein the identified relationship is used to identify target parts that are more expensive compared to the should cost determination of the target part.

15. A method of determining machined parts similar to a target part comprising the steps of:
a) provide pre-determined variables relating to features characteristics of the similar parts;
b) assigning the pre-determined variables as feature vectors;
c) defining said vectors as points in a feature space;
d) defining a reference point in said feature space based upon the target part;
e) normalizing each point in a feature space; and
f) calculating the distance between the points representing the similar parts and the reference points using a distance metric.

16. The method of claim 15, wherein the determination of a should cost target part price includes the step of calculating the Euclidean distance between the points representing the similar parts and the reference points.

17. The method of claim 15, wherein the determination of a should cost target part price includes the step of identifying similar parts designated as nearest neighbors.

18. The method of claim 8, wherein the determination of a should cost target price includes the step of identifying part cost factors designated as said cost drivers.

19. The method of claim 15, wherein the determination of a should cost target part price includes the step of analyzing the capabilities of potential target part suppliers, including identifying the core capabilities of such suppliers to efficiently furnish target parts.

20. The method of claim 2, including the step of acquiring features characteristics, financial information and purchasing demand information selected from the group consisting of computer assisted drawing (CAD) files, engineering specifications related to the target part files, demand data from Enterprise Resource Planning (ERP) systems, and cost data from financial systems related to the target part.

21. The method of claim 1, wherein the method of managing costs is provided to a user in a browser interface.

22. The method of claim 1, including the steps of data loading, and the additional step of applying business rules in the steps of acquiring and loading features characteristics, financial and purchasing demand information.

23. The method of claim 21, wherein the data loading business rules aggregate data from a plurality of sources and creates a should cost data base that is reusable across said sources.

24. The method of claim 21, wherein the step of acquiring and processing features characteristics information includes extracting engineering file information describing the physical characteristic of the target part.

25. The method of claim 21, wherein the step of acquiring and processing physical characteristic information includes extracting machining specification information related to the target part.

26. The method of claim 21, wherein the step of acquiring features characteristics information of the target part includes extracting information from computer assisted drawings (CAD).

27. The method of claim 21, wherein the data loading business rules transform, normalize and validate target part data as said data is stored in the data base.

28. The method of claim 1, wherein the data managing layer analyzes at least one of two dimensional target part drawings and three dimensional target part engineering models and extracts features that are predictive of costs of the target part.

29. The method of claim 2, including the steps of:
a) extracting batch data from customer delivered formats;
b) loading the batch data into memory;
c) aggregating, categorizing and filtering the batch data based on customer defined rules;
d) loading the data based on customer defined rules into a data base;
e) analyzing the batch data in the data base to generate exception reports providing a user with data load failure or exception information.

30. The method of claim 28, including the additional step of applying business rules to determine extreme values and eliminate extreme values.

31. The method of claim 29, including the step of performing a model fitting algorithm analysis.

32. A method of managing costs by evaluating suppliers of a target part comprising the steps of:
a) providing at least one part produced by at least one source;
b) calculating a range of values for at least one predetermined part source category for the at least one part of the at least one source;
c) comparing part source category values of a target part to the calculated values for the at least one predetermined category for the at least one part of the at least one source; and
d) calculating a fit rating for said source based on said comparison.

33. A method of managing costs of a target part including the steps of:
a) loading data as to target part features characteristics information, financial information, demand information and source information;
b) performing model fitting algorithms with the loaded data;
c) eliminating extreme statistical data;
d) extracting said data from a database and loading said data into an analytical engine;
e) performing the following model fitting algorithms analysis including:
(i) calculating a should cost for the target part;
(iii) calculating cost drivers;
(iv) performing a nearest neighbor analysis; and
(v) performing a sourcing analysis;
f) exporting and storing the analytical results to a relationable database.

34. A method of managing costs of a target part comprising the steps of:
a) providing features characteristics information, of the target part;
b) providing financial information related to the target part;
c) providing purchasing demand information related to the target part;
d) analyzing the features characteristics data, financial information, and purchasing demand information;
e) determining from said analysis a prediction of what the target part should cost; and
f) comparing the target part should cost to a supplier's price of the target part to determine cost saving opportunities.

35. A method of managing costs of a target part comprising the steps of:
a) extracting at least one predefined cost predictive features variable selected from the group consisting of financial, purchasing and feature information;
b) analyzing the features characteristics data, financial information, and purchasing demand information;
c) determining from said analysis a prediction of what the target part should cost; and
d) comparing the target part should cost to a supplier's price of the target part to determine cost saving opportunities.

36. The method of claim 35, wherein the step of extracting the financial information includes at least one features variable selected from the group consisting of Part Number, Part Name, Engineering Change Number, Forecasted Annual Demand, Demand Past 12 Months, Base Part Price, Packaging, Painting, Other, Material Surcharge, Export Charges, Storage/Warehousing, Tooling, and Premium Charge.

37. The method of claim 35, wherein the step of extracting the purchasing information includes at least one features variable selected from the group consisting of Segment, Family, Class, Supplier, Buyer, Finishes Status, Part Weight, Quoted Annual Demand and Quote Date.

38. The method of claim 35, wherein the step of extracting the feature information includes at least one features variable selected from the group consisting of Material, Casting Cost, Part Features, Machining Cost and Assembly Cost.

39. The method of claim 38, wherein the step of extracting the feature information includes at least one Material selected from the group consisting of Aluminum, Brass, Ductile Iron, Gray Iron, Malleable Iron, and Steel.

40. The method of claim 38, wherein the step of extracting the feature information includes at least one Casting Cost selected from the group consisting of Height, Width, Depth, Surface Area, Part Volume, Box Volume And Finished Weight.

41. The method of claim 38, wherein the step of extracting the feature information includes at least one Part Features selected from the group consisting of Cores, Core Volume, Pressure Test-Air, Pressure Test-Fuel, Pressure Test-Oil And Pressure Test-Water.

42. The method of claim 38, wherein the step of extracting the feature information includes at least one Machining Cost selected from the group consisting of Ports, Port Volume, Drill Holes, Drill Hole Volume, Heat Treat, Parting Line Perimeter Grinding, Machine Setups, Riser Removal, Surface Area Flatness, Forecasted Annual Demand And Log Annual Demand.

43. The method of claim 38, wherein the step of extracting the feature information includes at least one Assembly Cost selected from the group consisting of Bearings, Fasteners, and Seals.

44. A system for managing costs of a target part comprising:
a display screen for displaying information, wherein the information is stored in one or more fields, said display screen being configured to permit selection of the one or more fields;
a readable medium coupled to the display screen;
a microprocessor coupled to said readable medium, said microprocessor programmed with instructions for manipulating the information; and
a cost management system further comprising the steps of:
a) providing features characteristics information, of the target part;
b) providing financial information related to the target part;
c) providing purchasing demand information related to the target part;
d) analyzing the features characteristics data, financial information, and purchasing demand information;
e) comparing the target part should cost to a supplier's price of the target part to determine cost saving opportunities.

45. The system of claim 44, wherein the step of analyzing includes the determination of a should cost target part price.
